(19) United States
(12) Patent Application Publication
(10) Pub. No.: US 2026/0077414 A1
(43) Pub. Date: Mar. 19, 2026

(54) ARC-SHAPED OSCILLATING SAW BLADE WITH LARGE AND SMALL TEETH AND OSCILLATING SAW

(71) Applicant: HANGZHOU EASY CAN TOOLS CO., LTD., Hangzhou (CN)

(72) Inventors: Yifan WANG, Hangzhou (CN); Yunfeng Wang, Hangzhou (CN); Yingjie Cai, Hangzhou (CN)

(73) Assignee: HANGZHOU EASY CAN TOOLS CO., LTD., Hangzhou (CN)

(21) Appl. No.: 18/925,918

(22) Filed: Oct. 24, 2024

(30) Foreign Application Priority Data
Sep. 19, 2024 (CN) 202422289383.0

(51) Int. Cl. B23D 61/00

(52) U.S. Cl. CPC B23D 61/006

(57) ABSTRACT

An arc-shaped oscillating saw blade with large and small teeth and an oscillating saw are provided. The arc-shaped oscillating saw blade with large and small teeth includes a connecting part and a cutting part. Sawteeth of the cutting part are arranged in an arc shape, and a plurality of adjacent sawteeth form a sawtooth unit, and each sawtooth unit includes a plurality of large teeth and a plurality of small teeth, thus forming a structure with the large and small teeth interleaved. With structural design of the saw blade with interleaved large and small teeth, an effective cutting area of the saw blade can be increased. With design of incremented angles, the sawteeth distributed in the arc shape can be formed, which facilitates reducing of the impact and vibration in the cutting process and further improves the cutting accuracy.

### CROSS-REFERENCE TO RELATED APPLICATION

This Non-provisional application claims priority under 35 U.S.C. §119(a) on Chinese Patent Application No(s). 202422289383.0 filed on Sep. 19, 2024, the entire contents of which are hereby incorporated by reference.

### TECHNICAL FIELD

The disclosure relates to the technical field of oscillating saw blades, in particular to an arc-shaped oscillating saw blade with large and small teeth and an oscillating saw.

### BACKGROUND ART

A cutting end of a traditional oscillating saw blade, that is, its sawtooth part, is generally linear in shape, and there is no angle change between a tip and a center of a tooth. When this type of oscillating saw blade cuts different materials, a movement direction of the saw blade is parallel to a sawtooth direction, and a shape and arrangement of the sawtooth are single in type, which results in poor chip removal and heat dissipation ability of the saw blade and a rough cutting surface, which affects cutting effect, reduces cutting efficiency and adversely affects service life of the saw blade. In view of the above, the disclosure is proposed.

### SUMMARY

An object of this disclosure is to provide an arc-shaped oscillating saw blade with large and small teeth and an oscillating saw, which can optimize a structure of a saw blade to improve cutting efficiency, cutting effect and service life of products.

In order to solve above problems, the disclosure provides an arc-shaped oscillating saw blade with large and small teeth, which includes a connecting part and a cutting part. The connecting part is configured for connecting with an oscillating saw to realize installation of a saw blade. A cutting end with sawteeth is formed at an end of the cutting part, the sawteeth of the cutting part are arranged in an arc shape, and a plurality of adjacent sawteeth form a sawtooth unit, and each sawtooth unit includes a plurality of large teeth and a plurality of small teeth, so that a structure in which the large and small teeth are interleaved is formed at the cutting end of the cutting part.

Alternatively, difference between large and small teeth may involve one or more of parameters such as a tooth pitch, a tooth width, a cutting angle, a tooth tip angle and a tooth height.

It should be noted that an interleaved structure of large and small teeth described in this scheme is not limited to arrangement per one large tooth and one small tooth, but also includes an interleaved design per same number of large and small teeth which are continuously arranged in multiple, such as an interleaved design of two large teeth, two small teeth, two large teeth and two small teeth and so on, and also includes an interleaved design per different numbers of large and small teeth, such as an interleaved design of one large tooth, two small teeth, one large tooth and two small teeth and so on.

Preferably, a number of sawteeth in the sawtooth unit is N, with a value ranging from 2 to 12.

Further, numbers of large teeth and small teeth in the sawtooth unit is the same.

According to an embodiment of the disclosure, the sawtooth unit includes two large teeth and two small teeth arranged in sequence.

Optionally, with a center point of the saw blade as an origin, angles of connecting lines between the sawteeth or tips of the sawteeth at an outermost side of the sawtooth unit and the origin are arranged in increments, and the increments range from 0.1 to 0.5°, thus forming the sawteeth distributed in an arc shape, which facilitates reducing of impact and vibration in a cutting process and improves cutting accuracy. Optionally, the increments can be the same or different.

According to an embodiment of the disclosure, a distance A2 between tips of two adjacent large teeth is greater than a distance A1 between tips of two adjacent small teeth.

According to an embodiment of the disclosure, the distance between the tips of two adjacent large teeth ranges from 0.3 to 3 mm, and preferably the distance A2 is 1.8 mm.

According to an embodiment of the disclosure, the distance between the tips of adjacent small teeth ranges from 0.1 to 2.5 mm, and preferably the distance A1 is 1.5 mm.

According to an embodiment of the disclosure, the connecting part and the cutting part are in an integrated or split type, and when the split type is adopted, the connecting part and the cutting part are connected with each other through a connector, such as a bolt, welding or the like.

An oscillating saw includes the arc-shaped oscillating saw blade with large and small teeth.

The disclosure has beneficial effects that with structural design of the saw blade with interleaved large and small teeth, an effective cutting area of the saw blade can be increased, so that a cutting speed is increased, stress and heat in the cutting process can be facilitated to be dispersed, vibration and deformation of the saw blade are reduced, and cutting stability and accuracy are improved. Because a cutting force can be more evenly distributed for interleaved tooth rows, burrs and unevenness in the cutting process can be reduced, smoothness and accuracy of the cutting surface can be improved; and with design of incremented angles, the sawteeth distributed in the arc shape can be formed, which facilitates reducing of the impact and vibration in the cutting process and further improves the cutting accuracy.

When cutting hard materials or materials with irregular shapes, the interleaved tooth rows can better adapt to changes of a material surface and reduce risk of jamming and fracture, and the interleaved tooth rows can disperse the force borne by each tooth during cutting, avoiding risk of damage caused by excessive load on a single tooth, which facilitates improvement of service life of the saw blade.

### BRIEF DESCRIPTION OF THE DRAWINGS

The application will be further described with reference to the drawings and embodiments.

FIG. 1 is a front view of an arc-shaped oscillating saw blade with large and small teeth;

FIG. 2 is a bottom view of an arc-shaped oscillating saw blade with large and small teeth; and

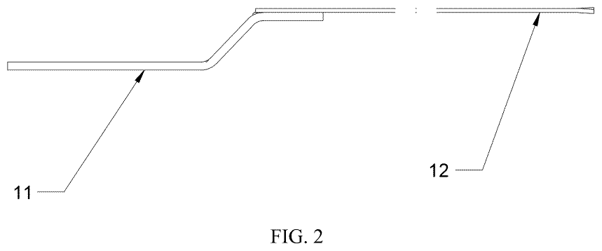

FIG. 3 is an enlarged schematic structural view of a sawtooth part.

### DETAILED DESCRIPTION

The following description is only intended to disclose the present disclosure so as to enable those skilled in the art to implement the disclosure. The embodiments in the following description are by way of example only, and other obvious variations will occur to those skilled in the art. The basic principle of the disclosure defined in the following description can be applied to other implementations, modified, improved and equivalent schemes and other schemes without departing from the spirit and scope of the disclosure.

### Embodiment 1

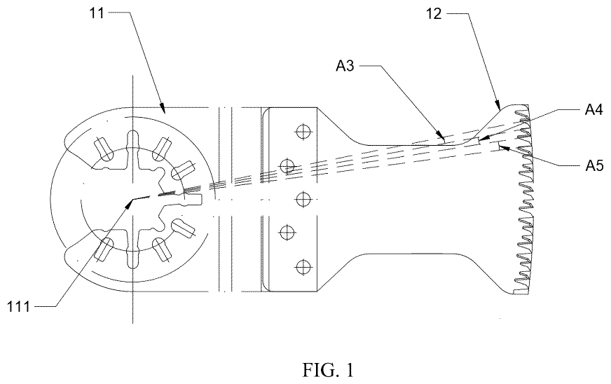

An arc-shaped oscillating saw blade with large and small teeth is provided as shown in FIG. 1, which includes a connecting part 11 and a cutting part 12. The connecting part 11 (also called a cutter pad) is configured for connecting with an oscillating saw to realize installation of a saw blade. Structural design of a connecting position is adaptively made according to an interface of the oscillating saw. A cutting end with sawteeth is formed at an end of the cutting part 12 (also called a saw blade), the sawteeth of the cutting part 12 are arranged in an arc shape, and a plurality of adjacent sawteeth form a sawtooth unit 13, and each sawtooth unit 13 includes a plurality of large teeth 131 and a plurality of small teeth 132, so that a structure in which the large and small teeth are interleaved is formed at the cutting end of the cutting part 12.

In a process of cutting materials by the saw blade, interleaved arrangement of the large and small teeth has significant effect on improving cutting effect. Its principle mainly lies in dispersing a cutting force, optimizing a cutting path and enhancing heat dissipation effect and others. Operation principle of this optimization in this scheme mainly involves following aspects.
1. Cutting efficiency is improved: interleaved arrangement of large and small teeth can increase the effective cutting area of the saw blade, thus increasing the cutting speed. This arrangement facilitates reducing of an idle stroke during sawing (the idle stroke is a process in which the saw blade does not cut effectively during moving), thus improving the cutting efficiency.
2. Cutting stability is enhanced:

The design of interleaved tooth rows facilitates dispersing of the stress and heat in the cutting process, which reduces the vibration and deformation of the saw blade, and thus improve the cutting stability and accuracy. When cutting hard materials or materials with irregular shapes, the interleaved tooth rows can better adapt to changes of a material surface and reduce risk of jamming and fracture. Moreover, interleaved large and small teeth can form a more complicated cutting path, which makes the saw blade more flexible to adapt to the change of material surface during cutting. This flexible cutting path facilitates reducing of resistance and friction during cutting, improves the cutting stability and further improve the cutting efficiency.
3. Cutting quality is improved:

Because the interleaved tooth rows can distribute the cutting force more evenly, it can reduce burr and unevenness caused in the cutting process and improve smoothness and accuracy of the cutting surface. Meanwhile, interleaved arrangement also facilitates reducing of noise and vibration in the cutting process, thus further improving operation environment and cutting quality.
4. Service life of the saw blade is improved:

The interleaved tooth rows can disperse the force borne by each tooth during cutting, avoiding risk of damage caused by excessive load on a single tooth. The design of incremented angles also facilitates reducing of the impact and vibration in the cutting process and improves the cutting accuracy.
5. Heat dissipation effect is enhanced:

The design of interleaved tooth rows facilitates increasing of a contact area between the saw blade or a cutter and air, thus improving the heat dissipation effect. Good heat dissipation can reduce damage by heat generated in the cutting process to the saw blade or cutter, prolong its service life and improve the cutting efficiency.

Further, in this embodiment, the sawtooth unit 13 is composed of two large teeth 131 and two small teeth 132, with a starting point on a left side of the saw blade (an upper end in FIG. 1) as a coordinate origin, respective sawtooth units are circularly arranged, and a number of cycles is not limited.

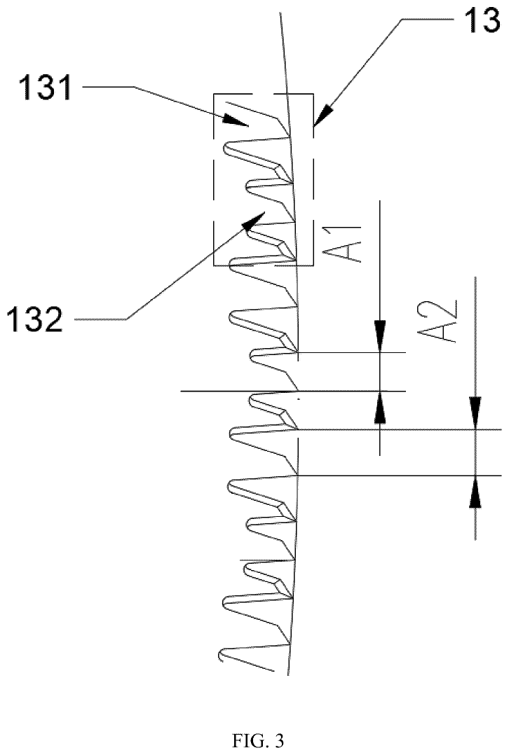

Embodiment 2: on a basis of Embodiment 1, as shown in FIG. 3, a distance A2 between tips of two adjacent large teeth 131 is greater than a distance A1 between tips of two adjacent small teeth 132.

Specifically, in this embodiment, the distance A2 between the tips of two adjacent large teeth 131 is 1.8 mm, and the distance A1 between the tips of adjacent small teeth 132 is 1.5 mm, which forms sawtooth gaps with different sizes, further facilitating chip removal.

Embodiment 3: On a basis of Embodiment 1 or 2, in this scheme, with a center point 111 of the saw blade as an origin, angles of connecting lines between the sawteeth or tips of the sawteeth at an outermost side of the sawtooth unit and the reference are arranged in increments. For example, in this embodiment, as shown in FIG. 1, included angles A5, A4 and A3 of connecting lines between tips of adjacent teeth and the origin are increased by 0.17 and 0.18 respectively, thus forming the sawteeth distributed in an arc shape, which facilitates reducing of impact and vibration in a cutting process and improves cutting accuracy.

An oscillating saw on which the arc-shaped oscillating saw blade with large and small teeth in any of above embodiments is mounted is provided. It should be appreciated by those skilled in the art that the above description and the embodiments of the disclosure shown in the drawings are only by way of example and do not limit the disclosure. The object of the disclosure has been completely and effectively achieved. The function and structural principle of the disclosure have been shown and explained in the embodiments; any variation and modification can be made to the embodiments of the disclosure without departing from the principle.

What is claimed is:

1. An arc-shaped oscillating saw blade with large and small teeth, comprising a connecting part and a cutting part, wherein sawteeth of the cutting part are arranged in an arc shape, and a plurality of adjacent sawteeth form a sawtooth unit, and each sawtooth unit comprises a plurality of large teeth and a plurality of small teeth, thus forming a structure with the large and small teeth interleaved. The arc-shaped oscillating saw blade with large and small teeth according to claim 1, wherein a number of the sawteeth in the sawtooth unit ranges from 2 to 12.

2. The arc-shaped oscillating saw blade with large and small teeth according to claim 2, wherein numbers of the large teeth and small teeth in the sawtooth unit is the same.

3. The arc-shaped oscillating saw blade with large and small teeth according to claim 3, wherein the sawtooth unit comprises a plurality of large teeth and a plurality of small teeth arranged in sequence.

4. The arc-shaped oscillating saw blade with large and small teeth according to claim 1, wherein with a center point of the saw blade as an origin, angles of connecting lines between the sawteeth or tips of the sawteeth at an outermost side of the sawtooth unit and the origin are arranged in increments, and the increments range from 0.1 to 0.5°.

5. The arc-shaped oscillating saw blade with large and small teeth according to claim 5, wherein a distance between tips of two adjacent large teeth is greater than a distance between tips of two adjacent small teeth.

6. The arc-shaped oscillating saw blade with large and small teeth according to claim 6, wherein the distance between the tips of two adjacent large teeth ranges from 0.3 to 3 mm.

7. The arc-shaped oscillating saw blade with large and small teeth according to claim 7, wherein the distance between the tips of two adjacent small teeth ranges from 0.1 to 2.5 mm.

8. The arc-shaped oscillating saw blade with large and small teeth according to claim 1, wherein a depth of a tooth gap between adjacent sawteeth is switched along with the switching of the large and small teeth.

9. An oscillating saw, comprising an arc-shaped oscillating saw blade with large and small teeth, wherein the arc-shaped oscillating saw blade with large and small teeth comprises a connecting part and a cutting part, wherein sawteeth of the cutting part are arranged in an arc shape, and a plurality of adjacent sawteeth form a sawtooth unit, and each sawtooth unit comprises a plurality of large teeth and a plurality of small teeth, thus forming a structure with the large and small teeth interleaved.
